(19) United States
(12) Patent Application Publication
(10) Pub. No.: US 2026/0366665 A1
(43) Pub. Date: Nov. 19, 2026

(54) PIPE JOINT

(71) Applicant: PILLAR CORPORATION, Osaka (JP)

(72) Inventors: Daisuke Urata, Osaka (JP); Keisuke Murata, Osaka (JP); Katsuhiko Fukui, Osaka (JP)

(73) Assignee: PILLAR CORPORATION, Osaka (JP)

(21) Appl. No.: 19/480,593

(22) PCT Filed: May 31, 2024
(86) PCT No.: PCT/JP2024/020006

§ 371 Date: Oct. 31, 2025

(30) Foreign Application Priority Data
Jun. 23, 2023 (JP) 2023-102904

(51) Int. Cl. F16L 47/04; F16L 25/01

(52) U.S. Cl. CPC F16L 47/04; F16L 25/01

(57) ABSTRACT

A pipe joint of the present disclosure is a pipe joint including: a tubular inner member having an inner peripheral surface which is a contact surface configured to come into contact with a transport fluid; a tubular joint member; and a union nut, the inner member being connected to a fluid device having a first thin-walled portion configured to come into contact with the transport fluid. The inner member includes an insulating annular second thin-walled portion having a thickness from the contact surface toward a radially outer side, and the thickness is smaller than a thickness of the first thin-walled portion, and the pipe joint includes a conductive portion provided in the joint member and in contact with an outer peripheral surface of the second thin-walled portion.

### TECHNICAL FIELD

The present invention relates to a pipe joint.

### BACKGROUND ART

In manufacturing apparatuses in various technical fields such as semiconductor manufacturing and medical/pharmaceutical manufacturing, a pipe joint described in PATENT LITERATURE 1 is known as a connection structure for connecting flow passages respectively formed in fluid devices such as tubes and diaphragm pumps. The pipe joint in PATENT LITERATURE 1 includes an inner ring mounted on the inner circumference of one end portion of a tube, a joint body mounted on the outer circumference of the one end portion of the tube, and a union nut mounted on the outer circumference of the joint body.

### CITATION LIST

### Patent Literature

PATENT LITERATURE 1: Japanese Laid-Open Patent Publication No. 2018-168947

### SUMMARY OF THE INVENTION

### Technical Problem

When an electrically charged transport fluid flows in the fluid device connected by the pipe joint, insulation breakdown such as a pinhole may occur in a thin-walled portion of the fluid device (e.g., a peripheral wall portion of a tube, a diaphragm membrane of a diaphragm pump, etc.) due to the charge. If such insulation breakdown occurs, it is necessary to replace the entire fluid device, and there is a problem that work for the replacement takes a great deal of time.

An object of the present disclosure is to inhibit insulation breakdown from occurring in a thin-walled portion of a fluid device connected to a pipe joint even when an electrically charged transport fluid flows in the fluid device.

### Solution to Problem

(1) A pipe joint of the present disclosure is a pipe joint including: a tubular inner member having an inner peripheral surface which is a contact surface configured to come into contact with a transport fluid; a tubular joint member fitted to an outer circumference of the inner member and having an external thread portion on an outer circumference thereof; and a union nut having, on an inner circumference thereof, an internal thread portion screwed onto the external thread portion, the inner member being connected to a fluid device having a first thin-walled portion configured to come into contact with the transport fluid, wherein the inner member includes an insulating annular second thin-walled portion having a thickness from the contact surface toward a radially outer side, and the thickness is smaller than a thickness of the first thin-walled portion, and the pipe joint includes a conductive portion provided in the joint member and in contact with an outer peripheral surface of the second thin-walled portion.

In the pipe joint of the present disclosure, when the electrically charged transport fluid flows in the inner member, the electric charges carried by the transport fluid pass through the second thin-walled portion in the radial direction and are discharged to the conductive portion, whereby insulation breakdown is likely to occur in the second thin-walled portion. Moreover, since the thickness of the second thin-walled portion is smaller than the thickness of the first thin-walled portion, insulation breakdown is likely to occur in the second thin-walled portion of the inner member before insulation breakdown occurs in the first thin-walled portion due to the electrically charged transport fluid flowing in the fluid device. Accordingly, it is possible to inhibit insulation breakdown from occurring in the first thin-walled portion of the fluid device.
(2) In the pipe joint of (1) above, preferably, the conductive portion has an annular protrusion having a shape tapered toward a radially inner side, and the outer peripheral surface of the second thin-walled portion is recessed to the radially inner side along the tapered shape of the annular protrusion.

In this case, the radial thickness of the second thin-walled portion is the smallest locally at a location corresponding to the protruding end of the annular protrusion, that is, at a location where the outer peripheral surface of the second thin-walled portion is most recessed to the radially inner side. Accordingly, insulation breakdown is likely to occur at the location in the second thin-walled portion earlier. As a result, it is possible to further inhibit insulation breakdown from occurring in the first thin-walled portion of the fluid device.
(3) In the pipe joint of (1) or (2) above, preferably, one of the conductive portion and the inner member has an engagement groove recessed in an axial direction, and the other of the conductive portion and the inner member has an engagement portion engaged with the engagement groove.

In this case, by the engagement portion being engaged with the engagement groove, the conductive portion can be held in a state of being brought into contact with the outer peripheral surface of the second thin-walled portion.
(4) Preferably, the pipe joint of any one of (1) to (3) above further includes a detection device configured to detect that insulation breakdown has occurred in the second thin-walled portion.

In this case, a manager of the pipe joint can quickly grasp that insulation breakdown has occurred in the second thin-walled portion of the inner member by the detection device, and thus can replace the inner member early. As a result, leakage of the transport fluid from a location where insulation breakdown has occurred in the second thin-walled portion can be reduced. Also, replacement of the fluid device is unnecessary, which can shorten the time required for replacement work.
(5) In the pipe joint of (4) above, preferably, the detection device includes a measuring instrument configured to measure electric charge in the conductive portion.

In this case, the detection device can directly detect that insulation breakdown has occurred in the second thin-walled portion, based on the electric charges in the conductive portion measured by the measuring instrument. Accordingly, the manager of the pipe joint can accurately and quickly grasp that insulation breakdown has occurred in the second thin-walled portion.

### Advantageous Effects of the Invention

According to the present disclosure, even when the electrically charged transport fluid flows in the fluid device connected to the pipe joint, it is possible to inhibit insulation breakdown from occurring in the thin-walled portion of the fluid device.

### BRIEF DESCRIPTION OF DRAWINGS

FIG. 1 is a cross-sectional view showing a pipe joint according to a first embodiment.

FIG. 2 is an enlarged cross-sectional view showing a main part of the pipe joint.

FIG. 3 is an enlarged cross-sectional view showing a main part of a pipe joint according to a second embodiment.

FIG. 4 is a cross-sectional view showing a pipe joint according to a third embodiment.

FIG. 5 is a cross-sectional view showing a pipe joint according to a fourth embodiment.

### DETAILED DESCRIPTION

Next, preferred embodiments of the present disclosure will be described with reference to the accompanying drawings.

### First Embodiment

### Entire Configuration of Pipe Joint

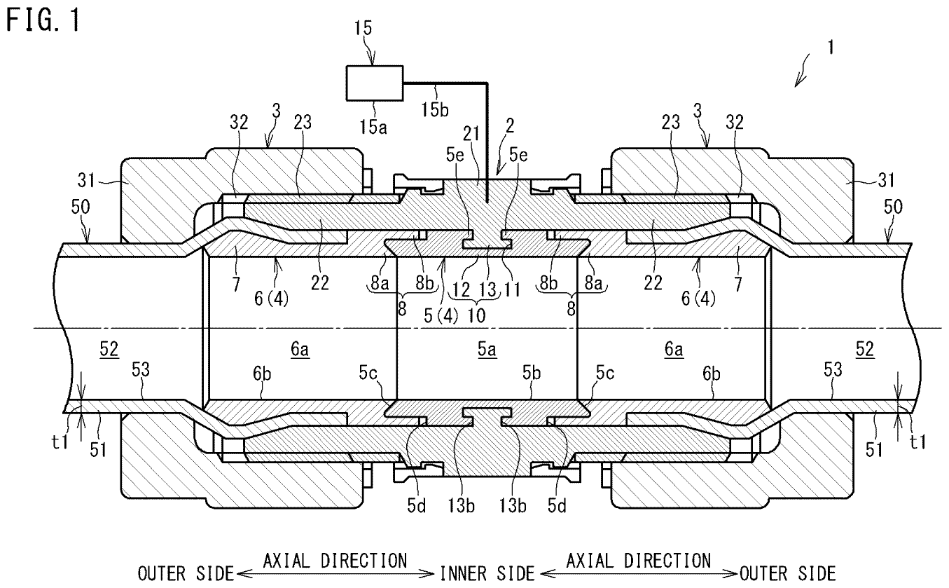

FIG. 1 is a cross-sectional view showing a pipe joint 1 according to a first embodiment. The pipe joint 1 is used to connect flow passages of two fluid devices, for example, in a pipe path through which a chemical solution used in a semiconductor manufacturing apparatus flows as a transport fluid. In the present embodiment, each of the two fluid devices is, for example, a tube 50 made of a synthetic resin.

Each tube 50 has a thin-walled portion (first thin-walled portion) 51 formed in a circular cross-sectional shape. The thin-walled portion 51 of the present embodiment is formed over the overall length in the longitudinal direction of the tube 50. A flow passage 52 through which the transport fluid flows is formed radially inward of the thin-walled portion 51 of the tube 50. The inner peripheral surface of the thin-walled portion 51 is a contact surface 53 which comes into contact with the transport fluid. The pipe joint 1 of the present embodiment is used to connect the flow passages 52 of both tubes 50.

The pipe joint 1 includes a joint member 2, a pair of union nuts 3, and an inner member 4. Hereafter, in the present embodiment, a direction from the center in the axial direction toward both sides in the axial direction of the pipe joint 1 is referred to as axially outer side, and a direction from each of both sides in the axial direction toward the center in the axial direction of the pipe joint 1 is referred to as axially inner side.

The inner member 4 includes a first ring 5 and a pair of second rings 6. The first ring 5 is placed at an axial center portion of the pipe joint 1. The second rings 6 are placed on both axially outer sides of the first ring 5. The first ring 5 and the second rings 6 are each formed in a cylindrical shape. The inner diameter of the first ring 5 and the inner diameter of each second ring 6 are the same.

The first ring 5 is made of an insulating synthetic resin material. Examples of the insulating synthetic resin material include polyvinyl chloride (PVC), polypropylene (PP), polyethylene (PE), or a fluorine resin (perfluoroalkoxy alkane (PFA), polytetrafluoroethylene (PTFE), polyvinylidene fluoride (PVDF), or the like). The first ring 5 of the present embodiment is made of a fluorine resin, since purity is required for the transport fluid (chemical solution) used in the semiconductor manufacturing apparatus. Each second ring 6 is made of the same synthetic resin material as the first ring 5, for example.

The internal space of the first ring 5 is a flow passage 5a through which the transport fluid flows. The inner peripheral surface of the first ring 5 is a contact surface 5b which comes into contact with the transport fluid. Similarly, the internal space of each second ring 6 is a flow passage 6a through which the transport fluid flows. The inner peripheral surface of each second ring 6 is a contact surface 6b which comes into contact with the transport fluid. The flow passage 5a of the first ring 5 and the flow passages 6a of the pair of second rings 6 communicate with each other.

A primary sealing groove 5c is formed on the radially inner side of each of both axially outer end portions of the first ring 5. The primary sealing groove 5c is a tapered groove that is cut such that the diameter thereof gradually increases from the contact surface 6b at the axially inner end thereof toward the axially outer end thereof. A secondary sealing groove 5d is formed on the radially outer side of each of both axially outer end portions of the first ring 5. The secondary sealing groove 5d is a step groove formed on the outer circumference of each of both axially outer end portions of the first ring 5.

Each second ring 6 has a bulge portion 7 and a sealing portion 8. The bulge portion 7 is formed on the axially outer side of the second ring 6 so as to project in a mountain shape toward the radially outer side. The bulge portion 7 is press-fitted into one end portion of the tube 50 to increase the diameter of the one end portion. Accordingly, the second ring 6 is connected to the one end portion of the tube 50. The sealing portion 8 is formed on the axially inner side of the second ring 6. The sealing portion 8 has a primary sealing portion 8a and a secondary sealing portion 8b.

The primary sealing portion 8a is formed in an annular shape on the radially inner side of the sealing portion 8. The diameter of the outer peripheral surface of the primary sealing portion 8a gradually increases from the axially inner end toward the axially outer end thereof. The primary sealing portion 8a is press-fitted into the primary sealing groove 5c of the first ring 5. The secondary sealing portion 8b is formed in a cylindrical shape on the radially outer side with respect to the primary sealing portion 8a. The secondary sealing portion 8b is press-fitted into the secondary sealing groove 5d of the first ring 5.

The joint member 2 is formed in a cylindrical shape from a material having conductivity. Examples of the material having conductivity include metals and conductive resins. The joint member 2 of the present embodiment is made of a carbon resin containing a filler having conductivity and chemical resistance. From the viewpoint of reducing environmental load, a recyclable conductive resin (fluorine resin, etc.) is preferably used for the joint member 2. Also, from the viewpoint of achieving weight reduction, a conductive resin (polypropylene, polyethylene, etc.) having a low specific gravity is preferably used for the joint member 2.

The inner peripheral surface of the joint member 2 is formed as a circumferential surface and is fitted to the outer circumference of the inner member 4 (first ring 5 and second ring 6). The joint member 2 has a joint body portion 21 and a pair of receiving portions 22. The joint body portion 21 is formed at an axial center portion of the joint member 2. The receiving portions 22 are formed on both axially outer sides of the joint member 2, respectively.

The second ring 6 in which the bulge portion 7 is press-fitted into the one end portion of the tube 50 is fitted to the inner circumference of the receiving portion 22 of the joint member 2. Accordingly, the one end portion of the tube 50 is held between the bulge portion 7 of the second ring 6 and the receiving portion 22 of the joint member 2. An external thread portion 23 is formed on the outer circumference of each receiving portion 22.

The union nut 3 is formed in a cylindrical shape, for example, from a synthetic resin material such as PVC, PP, PE, or a fluorine resin (PFA, PTFE, or the like). The union nut 3 has a pressing portion 31 and an internal thread portion 32. The pressing portion 31 is formed on the axially outer side of the union nut 3 so as to project toward the radially inner side. The internal thread portion 32 is formed on the inner circumference of the axially inner side of the union nut 3. The internal thread portion 32 is screwed onto the external thread portion 23 of the joint member 2. By the screwing, an axially inner end portion of the pressing portion 31 presses the outer peripheral surface of the tube 50 that bulges radially outward due to the bulge portion 7.

With the above configuration, when the internal thread portion 32 of the union nut 3 is screwed onto the external thread portion 23 of the joint member 2, the primary sealing portion 8a and the secondary sealing portion 8b of the second ring 6 are press-fitted into the primary sealing groove 5c and the secondary sealing groove 5d of the first ring 5, respectively. Accordingly, sealing performance at the connection portion between the first ring 5 and the second ring 6 and sealing performance between the outer peripheral surface of the second ring 6 and the inner peripheral surface of the joint member 2 are ensured. In addition, the pressing portion 31 of the union nut 3 can inhibit the one end portion of the tube 50 from being pulled out from the pipe joint 1.

As for the shape of the joint member 2, each receiving portion 22 on which the external thread portion 23 is formed may be formed in a cylindrical shape, and the joint body portion 21 may be formed in a cylindrical shape or in a polygonal tubular shape.

### Discharge Structure

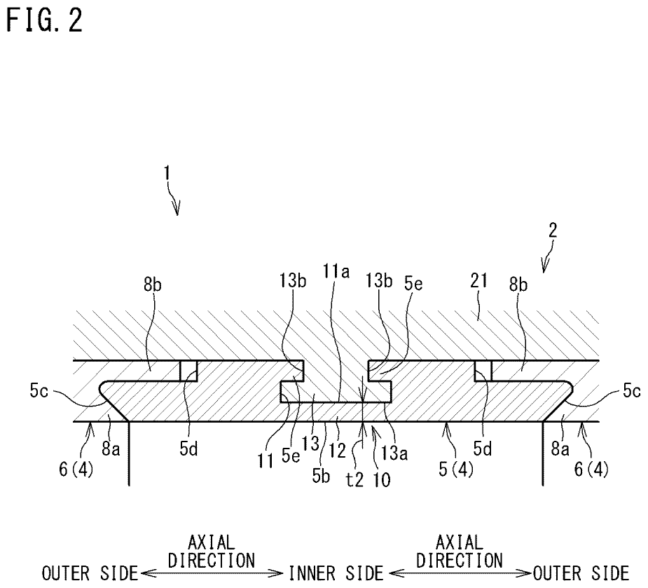

FIG. 2 is an enlarged cross-sectional view showing a main part of the pipe joint 1. The pipe joint 1 has a discharge structure 10 which induces discharge of electric charges carried by the transport fluid when the transport fluid is electrically charged. The discharge structure 10 is composed of a thin-walled portion (second thin-walled portion) 12 and a conductive portion 13. The details of the discharge structure 10 will be described below.

The first ring 5 has a fitting recess 11 and the thin-walled portion 12. The fitting recess 11 is formed at an axial center portion of the first ring 5 and is open on the outer peripheral surface of this axial center portion. The fitting recess 11 is formed in an annular shape over the entire circumference of the first ring 5.

The thin-walled portion 12 is formed between a bottom surface 11a of the fitting recess 11 and the contact surface 5b of the first ring 5 at the axial center portion of the first ring 5. The thin-walled portion 12 is formed in an annular shape over the entire circumference of the first ring 5. Hereinafter, the bottom surface 11a and the contact surface 5b are also referred to as outer peripheral surface 11a and inner peripheral surface 5b of the thin-walled portion 12, respectively.

Since the thin-walled portion 12 is a part of the first ring 5, the thin-walled portion 12 has insulating properties as described above. The thin-walled portion 12 has a thickness t2 from the inner peripheral surface 5b of the first ring 5 toward the radially outer side. The thickness t2 of the thin-walled portion 12 is smaller than a radial thickness t1 (see FIG. 1) of the thin-walled portion 51 of the tube 50.

The joint member 2 is provided with the conductive portion 13. The conductive portion 13 of the present embodiment is integrally provided on the joint body portion 21. Specifically, the conductive portion 13 projects from the inner peripheral surface of an axial center portion of the joint body portion 21 toward the radially inner side. The conductive portion 13 is formed in an annular shape over the entire circumference of the joint body portion 21 and is fitted into the fitting recess 11 of the first ring 5. An inner peripheral surface 13a of the conductive portion 13 is in surface contact with the outer peripheral surface 11a of the thin-walled portion 12. The conductive portion 13 is made of the same material as the joint member 2 and has conductivity. The conductive portion 13 may be provided as a member separate from the joint body portion 21.

The conductive portion 13 has a pair of engagement grooves 13b. The engagement grooves 13b are formed on both axial side surfaces of the conductive portion 13, respectively, so as to be recessed to the axially inner side. Each engagement groove 13b is formed in an annular shape over the entire circumference of the joint body portion 21.

The first ring 5 has a pair of engagement portions 5e. The engagement portions 5e project from both axial side surfaces of the fitting recess 11, respectively, toward the axially inner side. Each engagement portion 5e is formed in an annular shape over the entire circumference of the joint body portion 21 and is engaged with the engagement groove 13b of the conductive portion 13. Accordingly, the conductive portion 13 is held in a state of being fitted into the fitting recess 11.

With the above configuration, if the transport fluid is electrically charged, when the electric charges carried by the transport fluid pass through the flow passage 5a of the first ring 5, the electric charges pass through the thin-walled portion 12 in the radial direction and are easily discharged to the conductive portion 13. Since the electric charges are discharged to the conductive portion 13, insulation breakdown such as a pinhole is likely to occur in the thin-walled portion 12.

### Detection Device

In FIG. 1, the pipe joint 1 further includes a detection device 15 which detects that insulation breakdown has occurred in the thin-walled portion 12 of the inner member 4. The detection device 15 of the present embodiment includes a measuring instrument 15a and a lead wire 15b. The measuring instrument 15a measures electric charges discharged from the transport fluid to the conductive portion 13. As the measuring instrument 15a, for example, an oscilloscope, an ohmmeter, or the like is used.

One end portion of the lead wire 15b is electrically connected to the measuring instrument 15a. Another end portion of the lead wire 15b is embedded in the joint body portion 21 and is electrically connected to the joint body portion 21. The measuring instrument 15a detects electric charges in the conductive portion 13 via the lead wire 15b and the joint body portion 21. The detection device 15 detects that insulation breakdown has occurred in the thin-walled portion 12, based on the electric charges measured by the measuring instrument 15a. Therefore, the detection device 15 of the present embodiment measures the electric charges in the conductive portion 13 which are directly related to insulation breakdown in the thin-walled portion 12, and thus can directly detect that insulation breakdown has occurred in the thin-walled portion 12.

When insulation breakdown in the thin-walled portion 12 is detected by the detection device 15, a manager of the pipe joint 1 is notified by a notification means, which is not shown, that the insulation breakdown has occurred in the thin-walled portion 12. The manager who has received this notification disassembles the pipe joint 1 and replaces at least the first ring 5 having the thin-walled portion 12 in which the insulation breakdown has occurred, with a new one.

The detection device 15 is not limited to that in the present embodiment and may indirectly detect that insulation breakdown has occurred in the thin-walled portion 12 of the inner member 4. For example, the detection device 15 may include a pressure sensor, a flow sensor, or a weight sensor. These sensors each measure changes in the pressure, flow rate, or weight of the transport fluid flowing through the flow passages 5a and 6a of the inner member 4 when the transport fluid leaks from a location where insulation breakdown has occurred in the thin-walled portion 12. Therefore, the detection device 15 can indirectly detect that insulation breakdown has occurred in the thin-walled portion 12, by measuring changes in the state of the transport fluid which are associated with the insulation breakdown in the thin-walled portion 12.

In addition, the detection device 15 may include a leak sensor or capacitance sensor that detects leakage of the transport fluid from a location where insulation breakdown has occurred in the thin-walled portion 12. In this case as well, the detection device 15 can indirectly detect that insulation breakdown has occurred in the thin-walled portion 12, by detecting leakage of the transport fluid which is associated with the insulation breakdown in the thin-walled portion 12.

### Advantageous Effects

In the pipe joint 1 of the first embodiment, when the electrically charged transport fluid flows through the flow passages 5a and 6a of the inner member 4, the electric charges carried by the transport fluid pass through the thin-walled portion 12 of the first ring 5 in the radial direction and are discharged to the conductive portion 13, whereby insulation breakdown is likely to occur in the thin-walled portion 12. Moreover, the thickness t2 of the thin-walled portion 12 of the first ring 5 is smaller than the thickness t1 of the thin-walled portion 51 of the tube 50. Therefore, insulation breakdown is likely to occur in the thin-walled portion 12 of the first ring 5 before insulation breakdown occurs in the thin-walled portion 51 due to the electrically charged transport fluid flowing through the flow passage 52 of the tube 50. Accordingly, it is possible to inhibit insulation breakdown from occurring in the thin-walled portion 51 of the tube 50.

By each engagement portion 5e of the first ring 5 being engaged with the engagement groove 13b of the conductive portion 13, the conductive portion 13 is held in a state of being fitted into the fitting recess 11. As a result, the conductive portion 13 can be held in a state of being brought into contact with the outer peripheral surface 11a of the thin-walled portion 12 of the first ring 5.

The detection device 15 detects that insulation breakdown has occurred in the thin-walled portion 12 of the inner member 4. Accordingly, the manager of the pipe joint 1 can quickly grasp that insulation breakdown has occurred in the thin-walled portion 12, and thus can replace the inner member 4 early. As a result, leakage of the transport fluid from a location where insulation breakdown has occurred in the thin-walled portion 12 can be reduced. Also, replacement of the tube 50, which is a fluid device, is unnecessary, which can shorten the time required for replacement work.

The detection device 15 directly detects that insulation breakdown has occurred in the thin-walled portion 12, based on the electric charges in the conductive portion 13 measured by the measuring instrument 15a. Accordingly, the manager of the pipe joint 1 can accurately and quickly grasp that insulation breakdown has occurred in the thin-walled portion 12.

### Second Embodiment

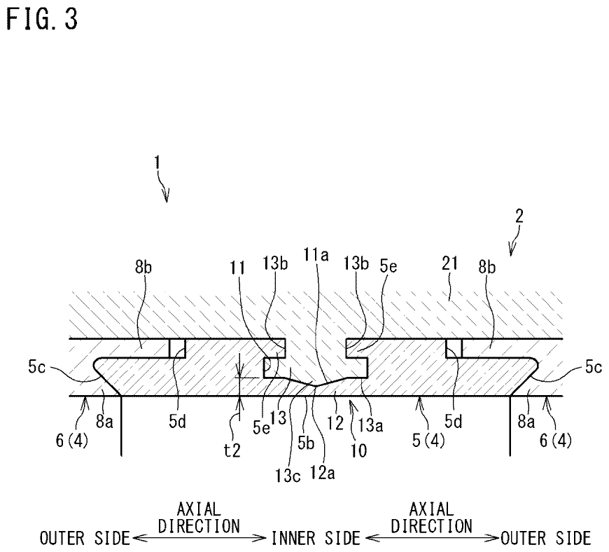

FIG. 3 is an enlarged cross-sectional view showing a main part of a pipe joint 1 according to a second embodiment. In the present embodiment, the shapes of the thin-walled portion 12 and the conductive portion 13 of the discharge structure 10 are different from those of the first embodiment. The conductive portion 13 of the present embodiment has an annular protrusion 13c having a shape tapered from the inner peripheral surface 13a toward the radially inner side. The annular protrusion 13c of the present embodiment is formed in a mountain-like cross-sectional shape at an axial center portion of the inner peripheral surface 13a. The annular protrusion 13c is formed in an annular shape over the entire circumference of the conductive portion 13.

The outer peripheral surface 11a of the thin-walled portion 12 is formed so as to be recessed to the radially inner side along the tapered shape of the annular protrusion 13c. In the present embodiment, the outer peripheral surface 11a of the thin-walled portion 12 is recessed in a V-shaped cross-sectional shape over the entire circumference at an axial center portion thereof. Accordingly, the annular protrusion 13c of the conductive portion 13 is in surface contact with the outer peripheral surface 11a of the thin-walled portion 12.

The thickness t2 of the thin-walled portion 12 is the smallest locally at a location corresponding to the protruding end of the annular protrusion 13c, that is, at a location 12a where the outer peripheral surface 11a of the thin-walled portion 12 is most recessed to the radially inner side. The other components of the present embodiment are the same as those of the first embodiment, and thus are designated by the same reference signs, and the description thereof is omitted.

In the pipe joint 1 of the present embodiment as well, the same advantageous effects as those of the first embodiment are achieved. Also, in the present embodiment, the thickness t2 of the thin-walled portion 12 is the smallest locally at the location 12a where the outer peripheral surface 11a of the thin-walled portion 12 is most recessed to the radially inner side. Accordingly, insulation breakdown is likely to occur at the location 12a in the thin-walled portion 12 earlier. As a result, it is possible to further inhibit insulation breakdown from occurring in the thin-walled portion 51 of the tube 50.

### Third Embodiment

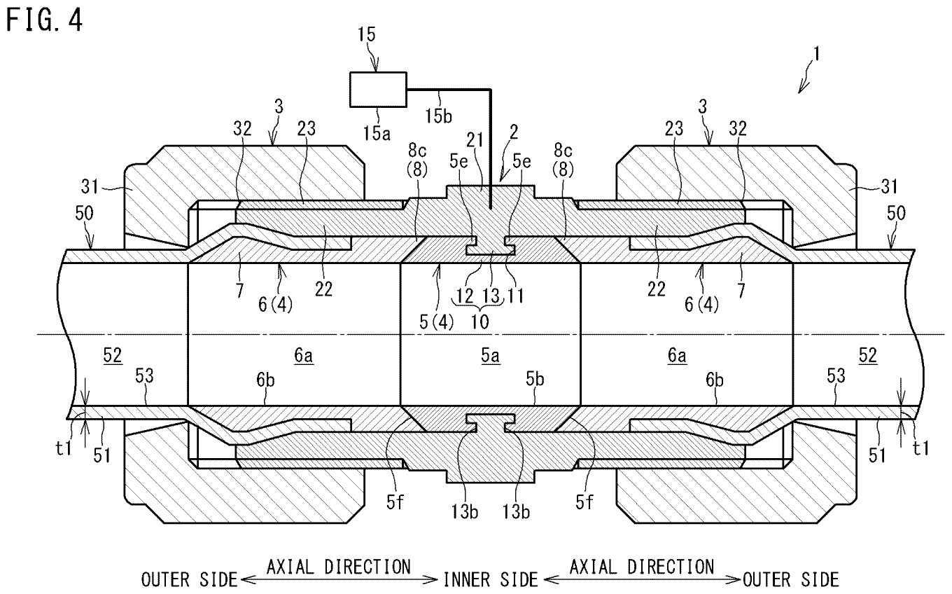

FIG. 4 is a cross-sectional view showing a pipe joint 1 according to a third embodiment. In the present embodiment, the connection structure between the first ring 5 and each second ring 6 of the inner member 4 is different from that of the first embodiment. A primary sealing groove 5f is formed on the entirety in the radial direction of each of both axially outer end portions of the first ring 5 of the present embodiment. The primary sealing groove 5f is a tapered groove that is cut such that the diameter thereof gradually decreases from the axially inner end thereof toward the contact surface 6b at the axially outer end thereof.

The sealing portion 8 of each second ring 6 is composed only of a primary sealing portion 8c. The primary sealing portion 8c is formed in an annular shape on the axially inner side of the sealing portion 8. The diameter of the inner peripheral surface of the primary sealing portion 8c gradually decreases from the axially inner end toward the axially outer end thereof. The primary sealing portion 8c is press-fitted into the primary sealing groove 5f of the first ring 5. Accordingly, sealing performance at the connection portion between the first ring 5 and the second ring 6 is ensured.

The other components of the present embodiment are the same as those of the first embodiment, and thus are designated by the same reference signs, and the description thereof is omitted. In the pipe joint 1 of the present embodiment as well, the same advantageous effects as those of the first embodiment are achieved.

### Fourth Embodiment

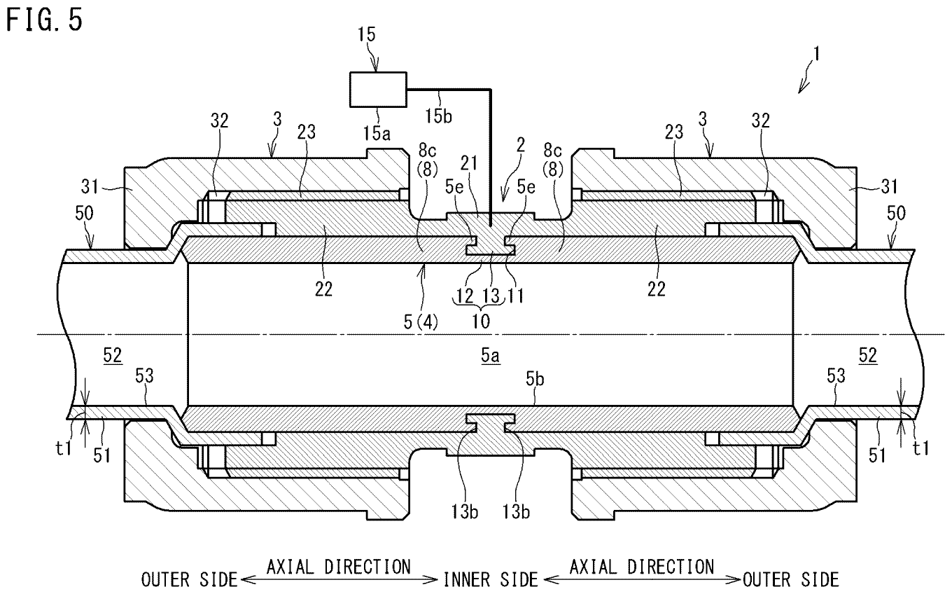

FIG. 5 is a cross-sectional view showing a pipe joint 1 according to a fourth embodiment. In the present embodiment, the configuration of the inner member 4 is different from that of the first embodiment. The inner member 4 of the present embodiment is composed only of a first ring 5. The first ring 5 of the present embodiment is formed longer on the axially outer side than in the first embodiment. Both axially outer end portions of the first ring 5 are each press-fitted into one end portion of the tube 50 to increase the diameter of the one end portion. Accordingly, the first ring 5 is connected to the one end portion of the tube 50.

The other components of the present embodiment are the same as those of the first embodiment, and thus are designated by the same reference signs, and the description thereof is omitted. In the pipe joint 1 of the present embodiment as well, the same advantageous effects as those of the first embodiment are achieved.

### Others

Each of the embodiments disclosed herein is merely illustrative and not restrictive in all aspects. For example, in each of the embodiments described above, each fluid device to which the inner member 4 is connected is not limited to the tube 50 as long as the fluid device has a thin-walled portion that comes into contact with the transport fluid. For example, the fluid device may be a diaphragm pump including a diaphragm membrane that is a thin-walled portion. In this case, the inner member 4 is connected to a tubular inlet pipe or outlet pipe in the diaphragm pump. In addition, since insulation breakdown occurs in the thin-walled portion 12 of the pipe joint 1 before insulation breakdown occurs in the diaphragm membrane, replacement of the diaphragm pump which is expensive is unnecessary. Therefore, replacement work can be performed in a short time and at low cost.

In the first to third embodiments described above, the thin-walled portion 12 of the discharge structure 10 is formed in the first ring 5, but may be formed in each second ring 6. In each of the embodiments described above, each engagement portion 5e is provided in the inner member 4, and each engagement groove 13b is provided on the conductive portion 13, but an engagement portion may be provided in the conductive portion 13, and an engagement groove may be provided on the inner member 4. The pipe joint 1 of the present disclosure can also be applied to the liquid crystal/organic EL field, the medical/pharmaceutical field, automotive-related fields, etc., in addition to a semiconductor manufacturing apparatus.

### REFERENCE SIGNS LIST

1 pipe joint
2 joint member
3 union nut
4 inner member
5b contact surface
5e engagement portion
11a outer peripheral surface
12 thin-walled portion (second thin-walled portion)
13 conductive portion
13b engagement groove
13c annular protrusion
15 detection device
15a measuring instrument
23 external thread portion
32 internal thread portion
50 tube (fluid device)
51 thin-walled portion (first thin-walled portion)
t1 thickness of first thin-walled portion
t2 thickness of second thin-walled portion

1. A pipe joint comprising:
a tubular inner member having an inner peripheral surface which is a contact surface configured to come into contact with a transport fluid;
a tubular joint member fitted to an outer circumference of the inner member and having an external thread portion on an outer circumference thereof; and
a union nut having, on an inner circumference thereof, an internal thread portion screwed onto the external thread portion,
the inner member being connected to a fluid device having a first thin-walled portion configured to come into contact with the transport fluid, wherein
the inner member includes an insulating annular second thin-walled portion having a thickness from the contact surface toward a radially outer side, and the thickness is smaller than a thickness of the first thin-walled portion, and
the pipe joint comprises a conductive portion provided in the joint member and in contact with an outer peripheral surface of the second thin-walled portion.

2. The pipe joint according to claim 1, wherein
the conductive portion has an annular protrusion having a shape tapered toward a radially inner side, and
the outer peripheral surface of the second thin-walled portion is recessed to the radially inner side along the tapered shape of the annular protrusion.

3. The pipe joint according to claim 1, wherein
one of the conductive portion and the inner member has an engagement groove recessed in an axial direction, and
the other of the conductive portion and the inner member has an engagement portion engaged with the engagement groove.

4. The pipe joint according to claim 1, further comprising a detection device configured to detect that insulation breakdown has occurred in the second thin-walled portion.

5. The pipe joint according to claim 4, wherein the detection device includes a measuring instrument configured to measure electric charge in the conductive portion.
